(19) United States
(12) Patent Application Publication
(10) Pub. No.: US 2023/0064318 A1
(43) Pub. Date: Mar. 2, 2023

(54) Shipping Container with Vacuum Insulated Panels Molded in Polyurethane

(71) Applicant: TCP Reliable Inc., Edison, NJ (US)

(72) Inventor: Jianyao Mou, Bridgewater, NJ (US)

(21) Appl. No.: 17/464,800

(22) Filed: Sep. 2, 2021

(51) Int. Cl. B65D 81/38; B29C 44/06; B29C 44/12

(52) U.S. Cl. CPC B65D 81/3858; B29C 44/06; B29C 44/1209; B65D 81/3862

(57) ABSTRACT

Disclosed is a thermal insulating shipping container with a five-sided box wherein a bottom and four sides all have an inner layer of corrugated polymer, a middle layer of shrink-wrapped panels with each panel being a vacuum panel, and an outer layer of corrugated polymer. The container is formed by inserting polyurethane liquid into the gaps and spaces between the shrink-wrapped panels and the inner and outer layers and foaming the polyurethane liquid and allowing it to harden. Weather stripping may be adhered to the edges of the container which are opposite to the bottom of the container.

### BACKGROUND

A vacuum is a popular means of temperature maintenance for container contents. Panels which have a vacuum within them that is insulated are convenient for shipping, as they can be quickly assembled to form a container with good insulating properties.

Vacuum insulated panels are often employed in the storage and transport of temperature-sensitive materials such as food, medicines, vaccines and the like. Such vacuum insulated panels typically comprise a membrane or barrier film which forms the panel walls and which keeps out gases and vapors; and a core material which provides physical support to the membrane or barrier film envelope and reduces heat transfer between the panel walls. Examples of such vacuum insulated panels are described in U.S. Pat. Nos. 5,950,450, 5,943,876 and 6,192,703, which are hereby incorporated by reference.

Polyurethane is another preferred material for insulation during shipment, as it is light and strong; once formed. One way to create a shipping container with excellent insulating properties is to inject polyurethane into spaces around and between vacuum insulated panels, and then generate polyurethane foam surrounding vacuum insulated panels. The polyurethane foam hardens to form solid and effective seals - which also help maintain the container structure.

An issue with foaming polyurethane around panels is that polyurethane will bind with the panel walls and tend to stretch the walls while expanding during foaming hardening - which can often rupture panel walls and completely destroy the vacuum and its insulation properties.

What is needed is a way to inject and foam polyurethane around vacuum insulated panels without significant risk of panel wall breach.

### SUMMARY

In the invention, vacuum insulated panels are shrink wrapped for protection from expansion of polyurethane during the foaming and hardening process. In a preferred embodiment, a shipping container is formed over a core mold. The container consists of an inner layer of plastic corrugated material surrounded by vacuum insulated panels; where the panels are surrounded by an outer layer of plastic corrugated material. In a preferred manufacturing process, there are five panels of each type -- forming the sides and bottom of the final container.

Raw polyurethane is then preferably injected from the open top of the container into gaps and spaces between the vacuum insulated panels and the outer layer; though it could be injected into additional gaps and spaces as well. The polyurethane is foamed using resin and isocyanate components with hydrofluoroolefin and water as the blowing agents, and allowed to harden.

After the foam has hardened, along the perimeter of the exposed upper side of the side wall panels, it is preferable to install weather strips to cover the exposed hardened polyurethane. This creates an improved seal with the container lid. The lid is also preferably formed from two plastic corrugated layers sandwiching a shrink wrapped vacuum insulated panel and with hardened polyurethane (following foaming) between the outer panel and the vacuum insulated panel.

Finally, the container and lid are preferably placed into a corrugated outer box, to form a completed, insulated shipping container. Optionally, a payload box could be added inside shipper to better protect the cargo during shipment. Preferably, either a temperature logger or a temperature and humidity logger is included, attached to the inner side of the lid or placed inside the container, for monitoring real time conditions experienced by the cargo.

Another innovation herein is to determine if the integrity of the container has been negatively affected, after putting a container with cargo in commerce, but before the temperature in the container changes sufficiently to damage the cargo. Vacuum panels are not good insulators if their integrity is damaged. If the damage occurs during shipment it may not be detected. Thus, it is a significant advantage to have a system to determine VIP panel damage as early as possible.

Such early detection can be accomplished with internal temperature and/or humidity monitoring, and determination of undue temperature variations. Some variance in the internal temperature is expected, but variations associated with damage to the container integrity can be differentiated from normal fluctuations.

The variances in the temperature can be correlated ambient conditions on a continuous basis, as the container is used in the field. This correlation can be continuously monitored and used to continuously update the determination of sound vs. breached containers based on field conditions and variations from controls and expectation, as monitored and determined by a machine learning program.

The invention will now be described in further detail with reference to the drawings.

### BRIEF DESCRIPTION OF THE DRAWINGS

FIG. 1A is an exploded perspective view of the mold core and the inner layer of the container.

FIG. 1B shows the components in FIG. 1A assembled.

FIG. 1C is a cross sectional view of the container inner layer in FIG. 1 along the plane A, B, C, D.

FIG. 1D shows an expanded view of a portion of the container inner layer in FIG. 1C.

FIG. 2A is an exploded perspective view, from one side, of five shrink wrapped vacuum insulated panels used in container construction described herein.

FIG. 2B is an exploded perspective view of the opposite side of five shrink wrapped vacuum insulated panels shown in FIG. 2A.

FIG. 3 is a perspective view showing the upper exposed flaps of a half-slotted container (HSC) plastic corrugated inner layer with four shrink wrapped vacuum insulated panels attached to the outer sides of four sides of the plastic corrugated inner layer.

FIG. 4A shows the same structure shown in FIG. 3 but with a fifth shrink wrapped vacuum insulated panel in place over the upper exposed flaps shown in FIG. 3.

FIG. 4B shows the same structure shown in FIG. 4A with the fifth shrink wrapped vacuum insulated panels taped in place.

FIG. 5A is an exploded view of the structure shown in FIG. 4B an outer layer of HSC plastic corrugated material, with the upper flaps open.

FIG. 5B is a perspective view of the structures shown in FIG. 5A with the outer layer of HSC plastic corrugated material in place and the upper flaps open and ready to receive foam.

FIG. 5C shows the same structure shown in FIG. 5B with the upper panels closed.

FIG. 6 shows the structure shown in FIG. 5C including an exploded view of mold side pieces to be attached to the base and to be clamped in place around the outer layer of HSC plastic corrugated material.

FIG. 7A shows the structure shown in FIG. 6 with all mold side pieces attached to the base and clamped in place around the outer layer of HSC plastic corrugated material, and with the mold cap exploded.

FIG. 7B is the same structure as FIG. 7A with the mold cap clamped in position.

FIG. 8A depicts the structure shown in FIG. 7B after removing the mold panels, cap and core.

FIG. 8B is a cross sectional view of the cooler in FIG. 8A along the plane E, F, G, H.

FIG. 9 shows the structure in FIG. 8 with weather strips in place along the upper edges of the side panels.

FIG. 10A is an exploded view of a lid mold base, a corrugated lid bottom, a VIP panel, a corrugated lid cover and a lid mold.

FIG. 10B is a perspective view of the components of the lid mold base and corrugated lid bottom in FIG. 10A in assembled form.

FIG. 11 is a perspective view of the lid mold base of FIG. 10B with a VIP panel resting on the plastic tray and foam having been added.

FIG. 12 is a perspective view of the lid mold base of FIG. 11 with a corrugated plastic pad covering the VIP panel.

FIG. 13A shows a mold cap in place over the lid mold base of FIG. 12.

FIG. 13B is a cross-section of FIG. 13A, taken through the plane W, X, Y, Z.

FIG. 14A is a perspective view of the lid produced when the mold cap in FIG. 13A is removed.

FIG. 14B is a cross-section of FIG. 14A, taken through the plane R, S, T, U.

FIG. 14C is a perspective view of the underside of the lid in FIG. 14A.

FIG. 14D is a perspective view of the lid of FIG. 14A exploded over the structure shown in FIG. 8/

FIG. 15 is a is a perspective view of underside of the lid of FIG. 14A showing a detachable real time data logging unit holder in place.

FIG. 16 is a is a perspective view of the finished container and lid.

FIG. 17A shows an exploded view of the finished container and a cardboard outer box.

FIG. 17B is a perspective view of the finished container inside the cardboard outer box with the flaps of the box open.

FIG. 17C is a perspective view of the finished container inside the cardboard outer box with the flaps of the box closed.

FIG. 18 is a chart showing test results showing the performance of a container of the invention and dry ice as the coolant.

### DETAILED DESCRIPTION

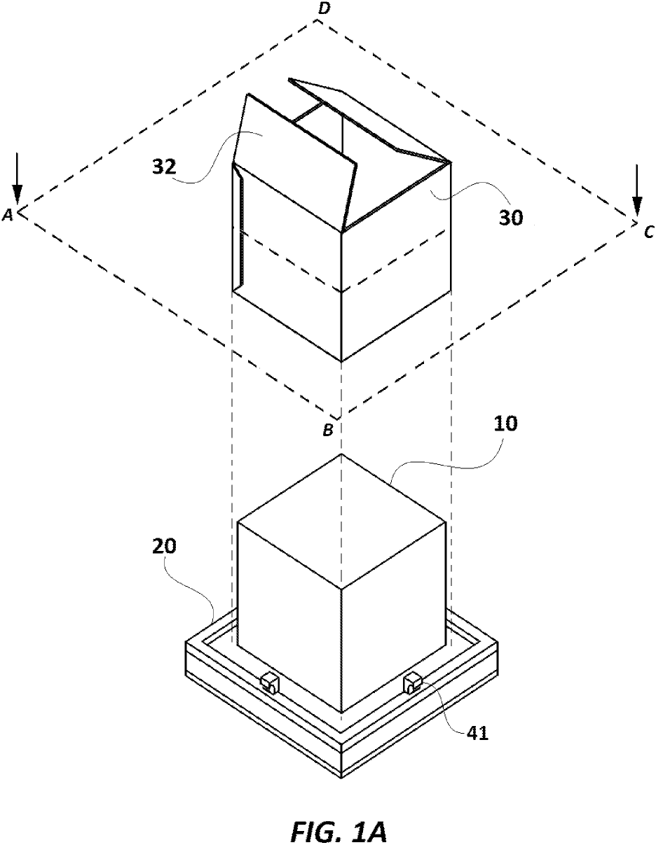

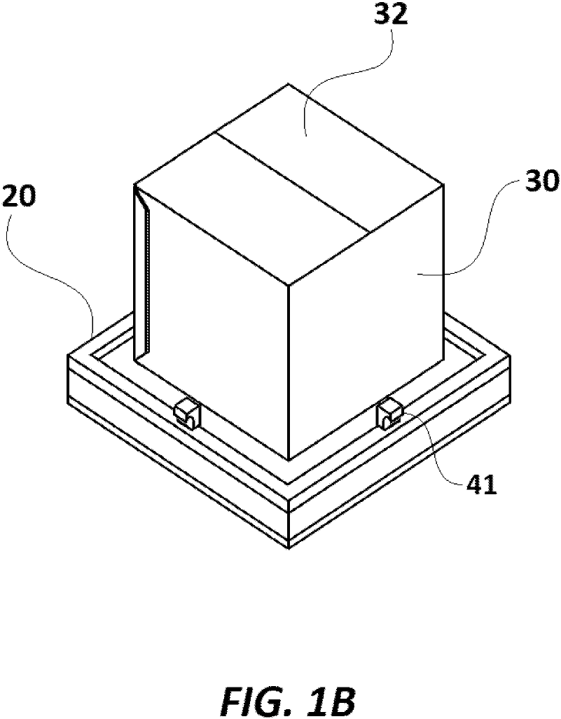

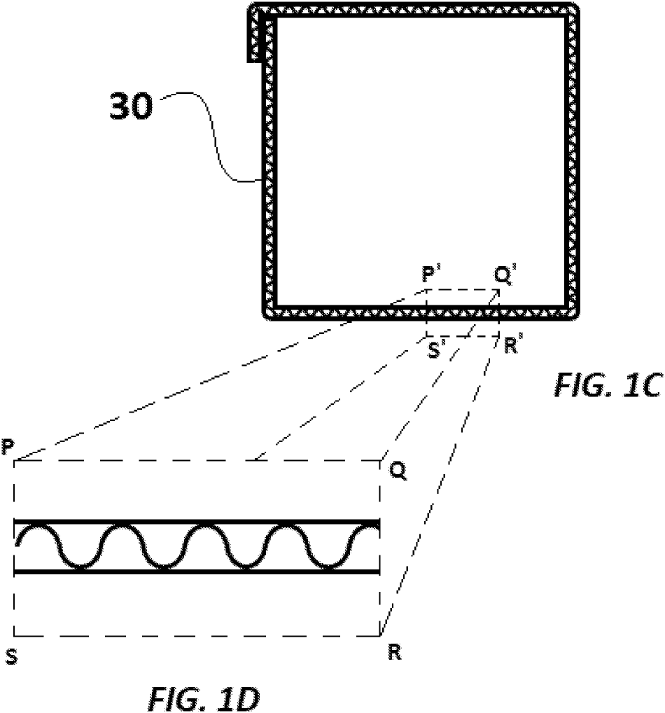

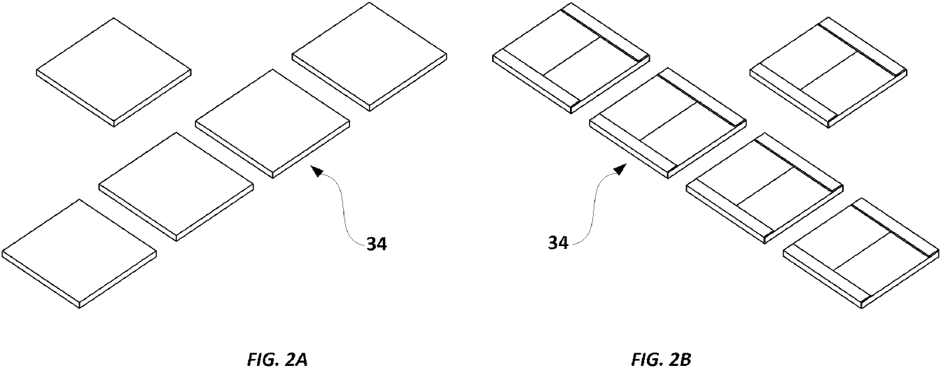

The manufacture of the shipping container of the invention, which includes shrink wrapped vacuum insulated panels (hereinafter “sVIPs”) sealed with foamed polyurethane, is set forth below to further explain the manufacturing process and the features of the shipping container produced in the process. Referring to FIGS. 1A-1D, a mold core 10 is depicted attached to a mold base panel 20, which bears hook 41 (for mold panel attachment). A half slotted container (HSC) 30, which preferably has its panels formed from corrugated plastic, is also shown. HSC containers have only one set of flaps (flaps 32 of HSC container 30) which form the bottom of the container, and typically have open tops. A cross section of HSC container 30 is shown in FIGS. 1C, 1D to better depict the corrugations.

In the first construction step, HSC container 30 is placed upside-down over mold core 10. As shown in FIGS. 1A-1D, HSC container 30 and mold core 10 are dimensioned to fit snugly when mated.

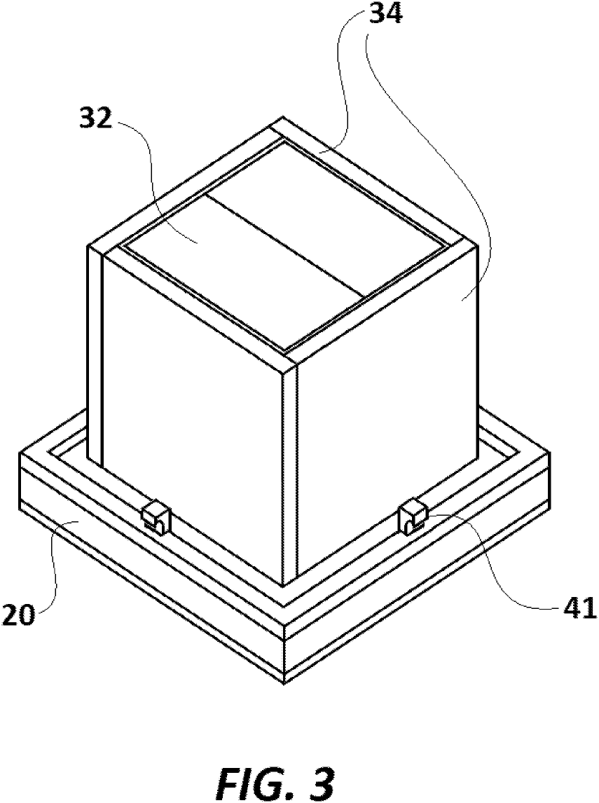

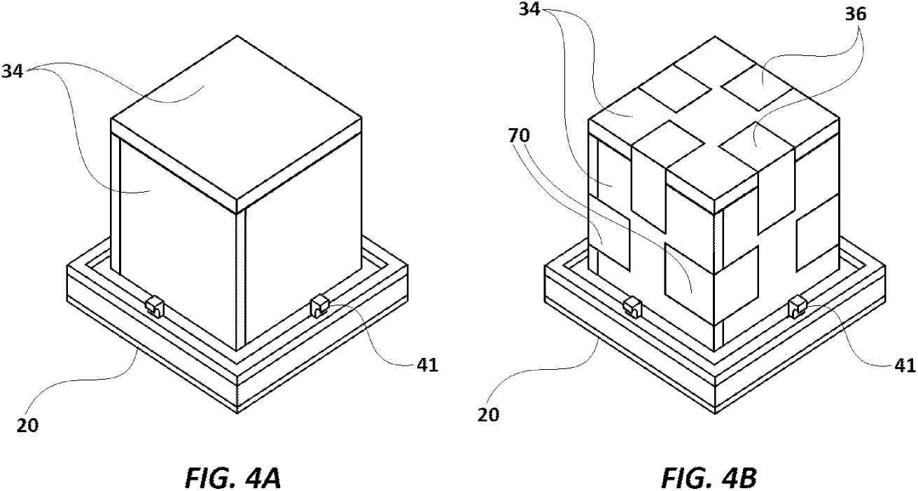

FIGS. 2A, 2B show five vacuum insulated panels (VIPs) 34 which have been shrink wrapped; i.e., fully enclosed in a clinging transparent plastic film that shrinks tightly on to it. The shrink wrapping protects the VIPs during the polyurethane foaming process. As shown in FIG. 3: four of the panels 34 are then attached (preferably taped) to the sides of HSC container 30, and adjusted to conform to the HSC container 30 sides such that the upper edges of the panels 34 and the HSC container 30 sides are co-planar.

Referring to FIGS. 4A, 4B: the last VIP panel 34 is secured to top of plastic corrugated box preferably using tape 36 to secure its upper surface to the to the upper edges and outer sides of the other four VIP panels 34; which can be done by stretching the tape 36 down before attaching it to the outer sides of the four VIP panels 34 as shown in FIG. 4B. It can be further taped to join together the four VIP panels 34 using tape 70.

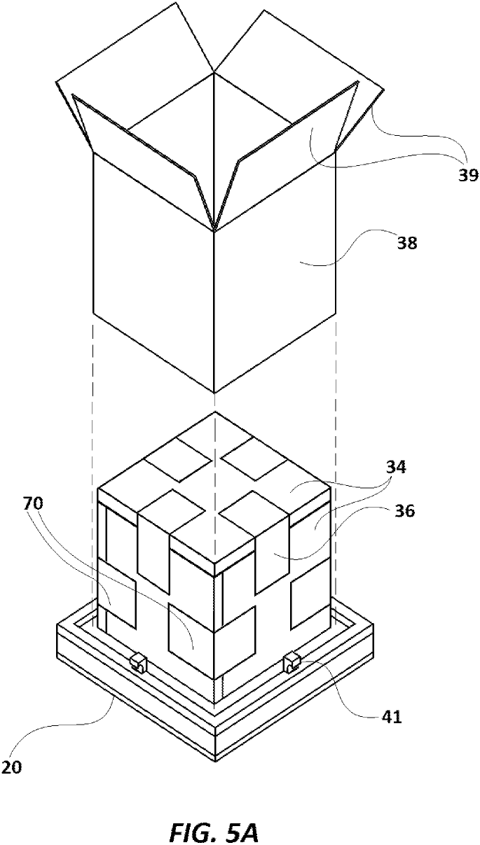

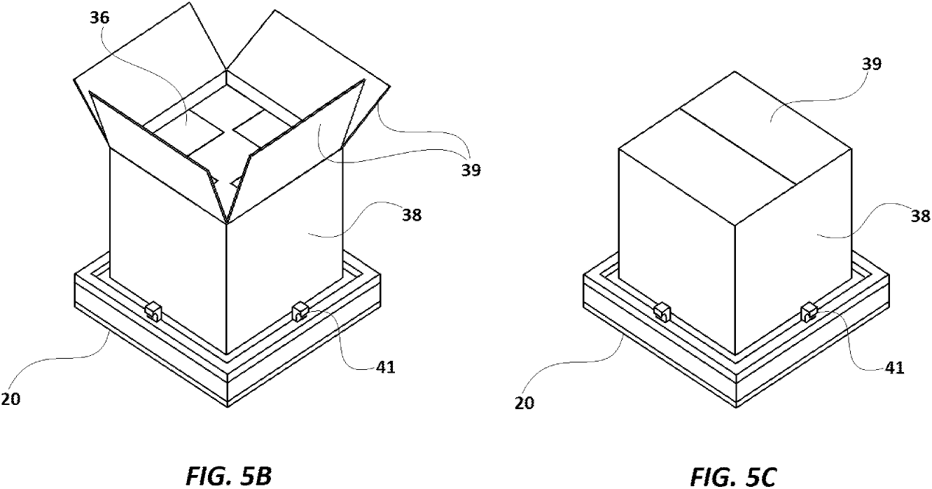

Next, a sufficiently large HSC plastic corrugated box 38 is placed to surround the outer sides of the four VIP panels 34, and then rested on the base of mold 40; as shown in FIGS. 5A-5C. The upper flaps 39 of box 38 are shown opened in FIG. 5B, ready to receive foam (as described below) and closed in FIG. 5C. The outer surfaces of the sides of box 38 will become outer surface of container.

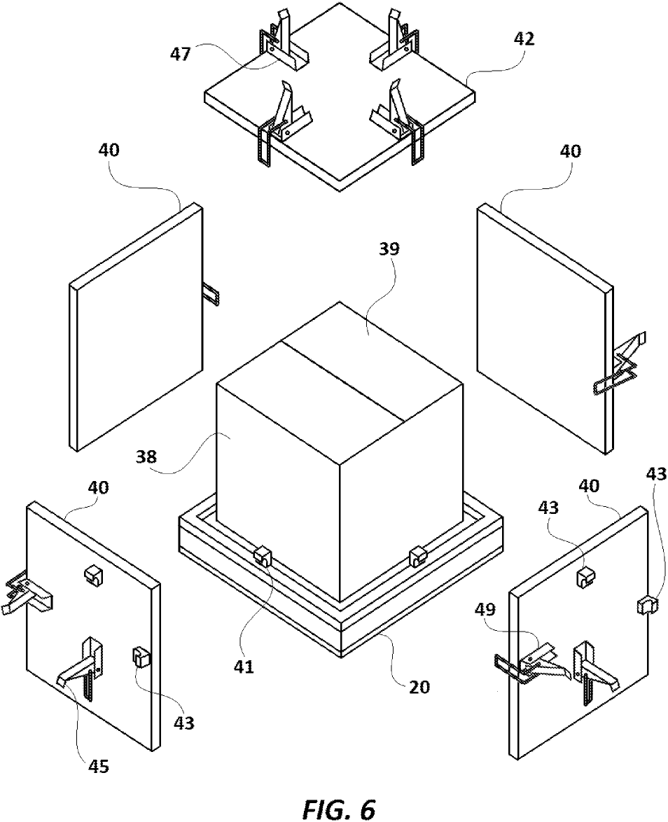

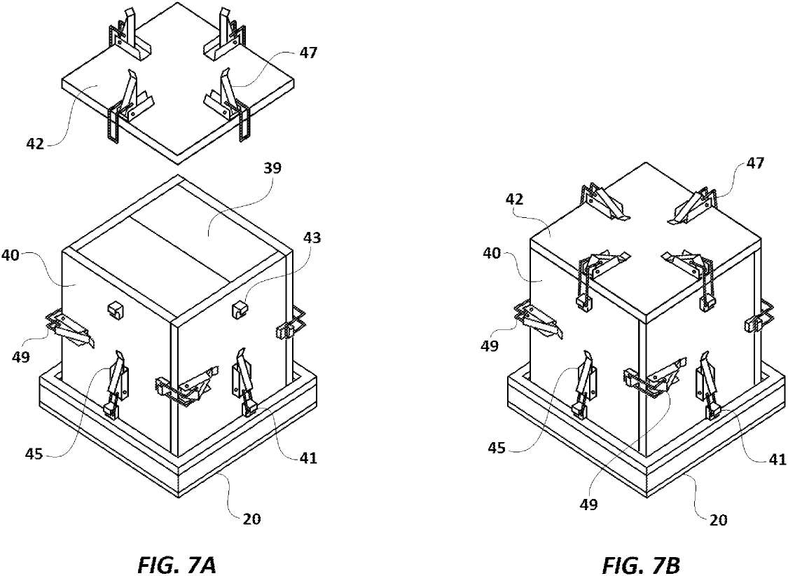

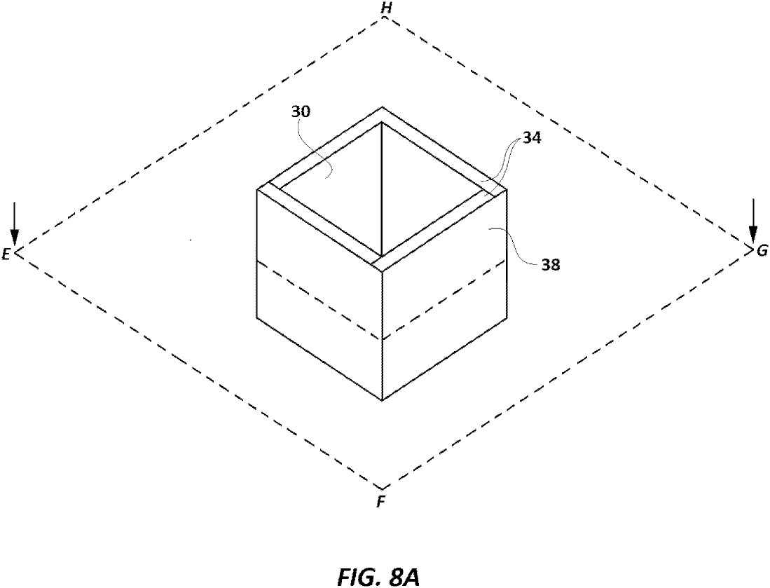

In the next step (FIGS. 6, 7A, 7B), the outer sides of the mold 40 are clamped tightly around the outer surface of box 38; by mating members 45 with hooks 41 on base 20 and mating the transverse members 49. With upper flaps 39 opened, as in FIG. 5A, one then pours the raw polyurethane material in along all the upper edges of four VIP panels 34, HSC container 30 sides and the sides of box 38, so as to fill gaps and spaces between VIP panels 34 and the container 30 sides and the sides of box 38. One then closes the flaps 39 and places on the mold cap 42, and mates members 47 and hooks 43 as in FIG. 7B.

Preferably, the polyurethane raw material is composed of isocyanate and resin, in a polymeric MDI based system. HFO and water are used as blowing agents in this system. When the components are mixed at injection nozzle at the specified reaction ratio, they react and initiate the foaming process. Foamed material then will cure and solidify. Other foaming processes could also be used, including foaming polyurethane following a well-known method using e.g. organic polyisocyanate with an organic compound containing at least two active hydrogen containing groups as determined by the Zerewitinoff method and also a blowing agent. See U.S. Pat. No. 3190442 (incorporated by reference).

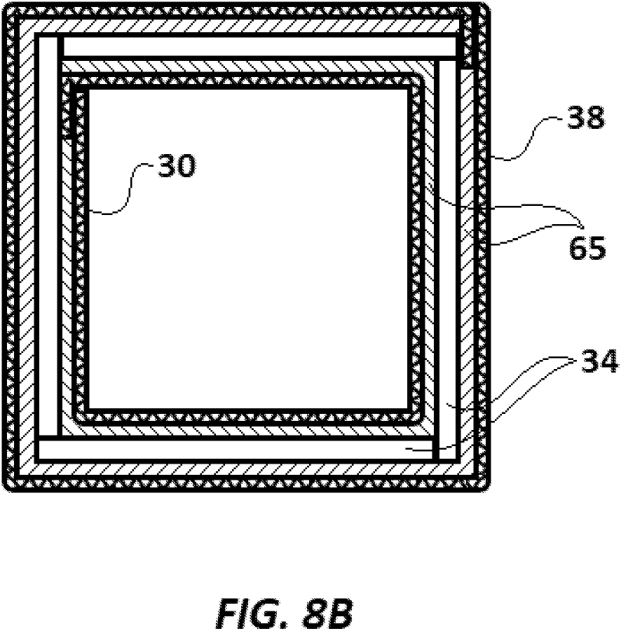

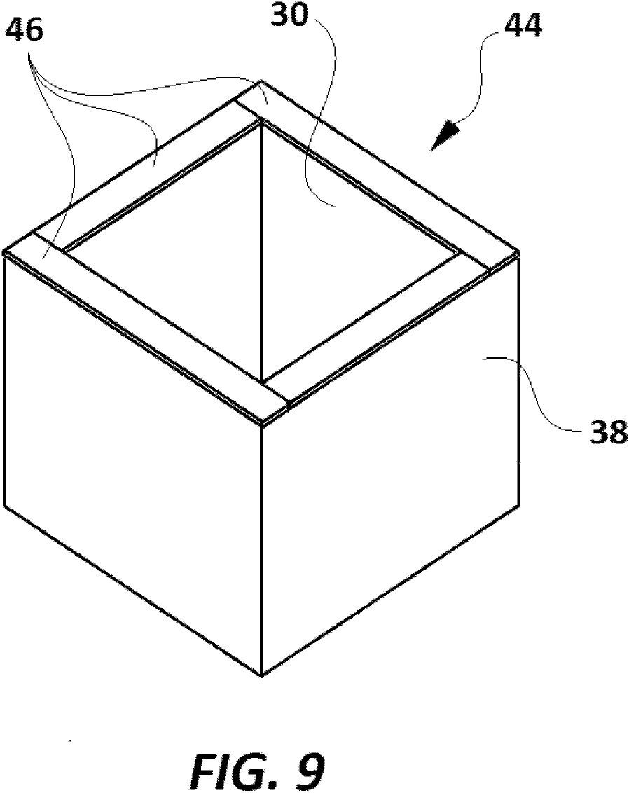

Once the foaming process for the polyurethane has had sufficient time to complete, the container 44 is released from mold by unclamping the sides 40 and cap 42 of the mold and then lifting container 44 from the mold core 10; leaving container 44 as shown in FIG. 8A (after inverting it so flaps 39 are at the base). In container 44, the hardened polyurethane 65 has filled all gaps and tightly bonded HSC container 30 sides with VIP panels 34 and with the sides of box 38 as shown in FIG. 8B. The hardened polyurethane 65 acts as a binder and buffer to maintain integrity of container 44, protect VIP panels 34 and also act as an insulation layer.

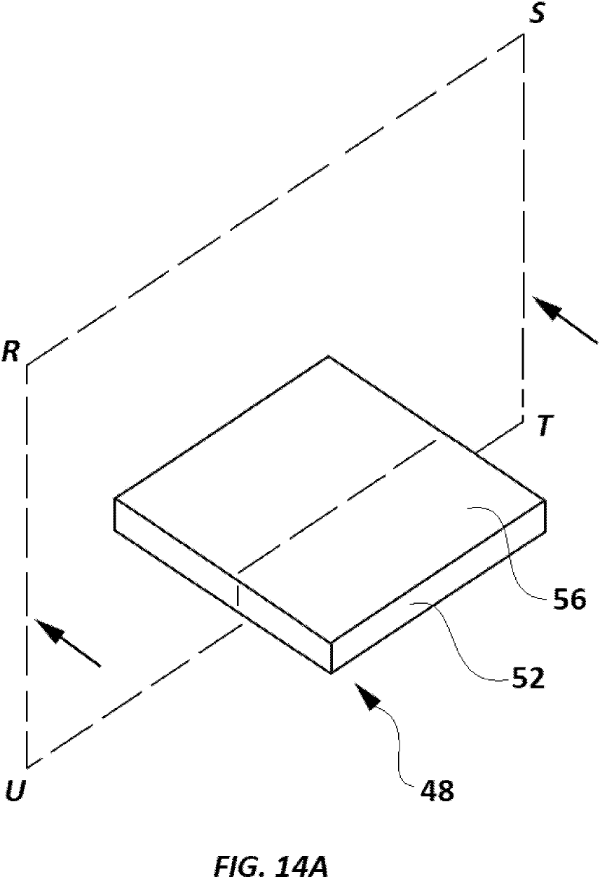

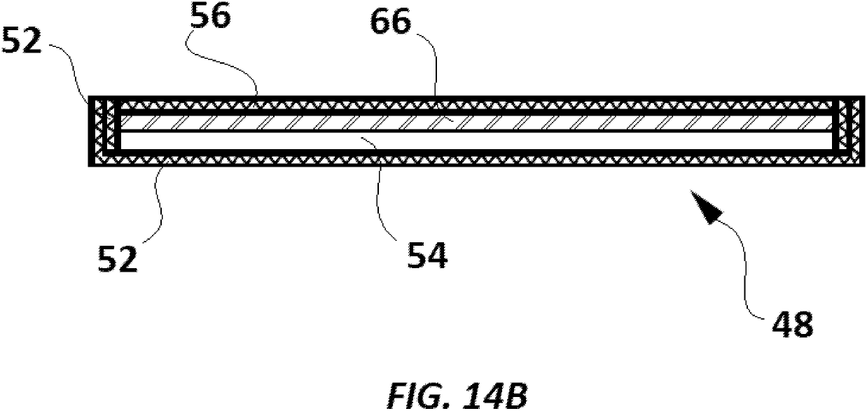

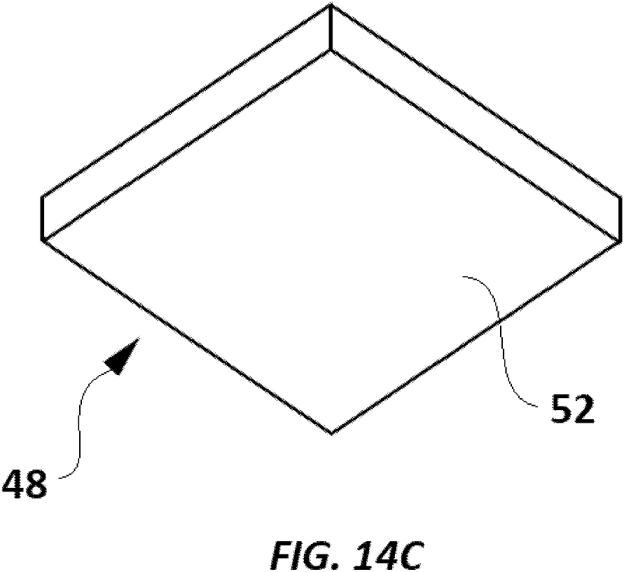

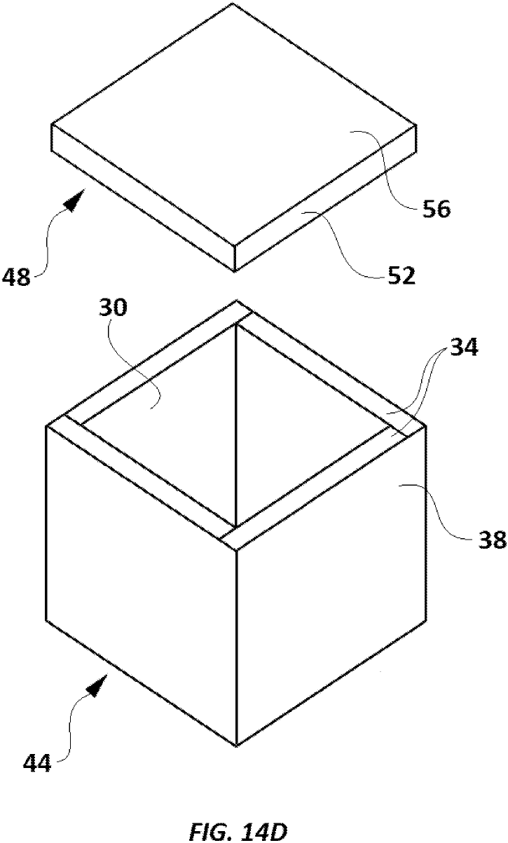

To complete container 44, weather strips 46 are added along the exposed edges of the HSC container 30, VIP panels 34 and box 38, as shown in FIG. 9. Weather strips 46 will help seal between the upper edges of container 44 and a lid 48 (FIG. 14A), to enhance insulation. Nevertheless, the seal between weather strips 46 and lid 48 will allow pressurized gas to release from inside container 44, which is important, for example, where dry ice is included as a coolant.

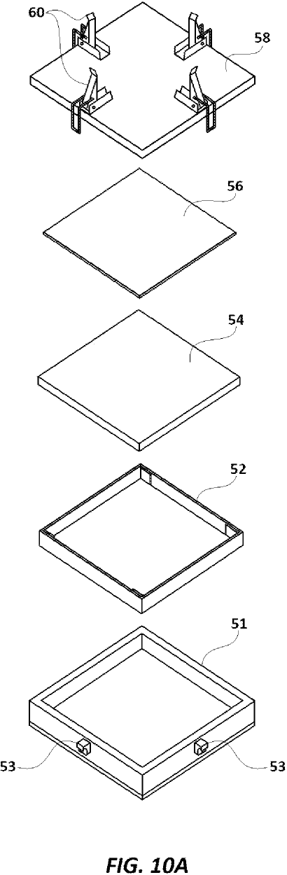

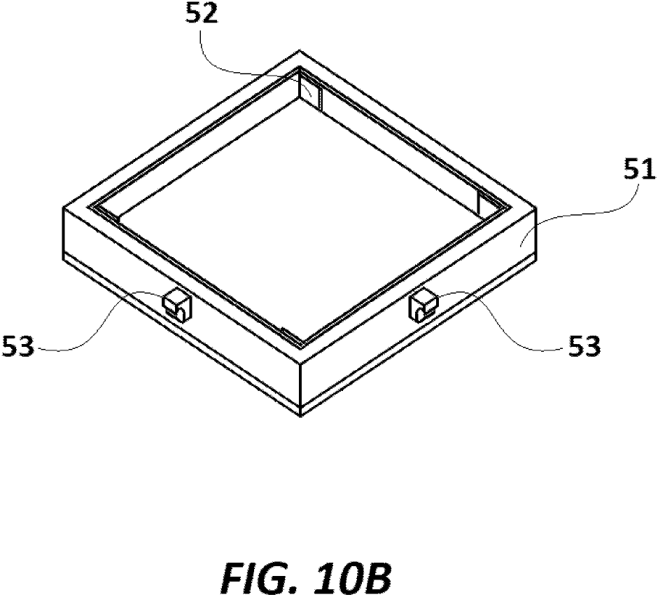

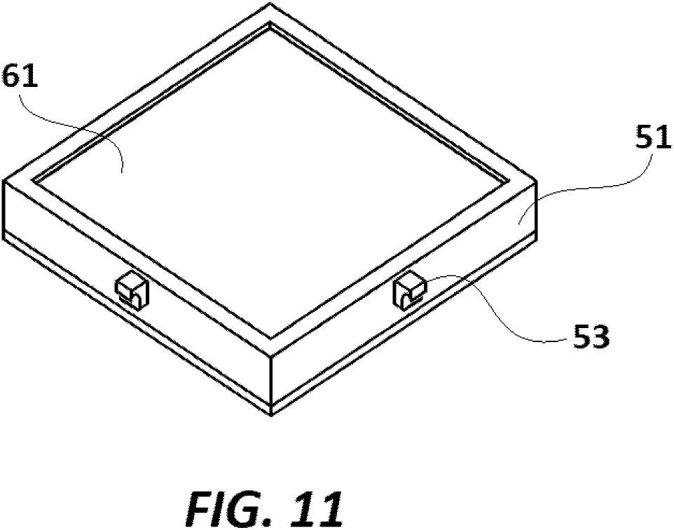

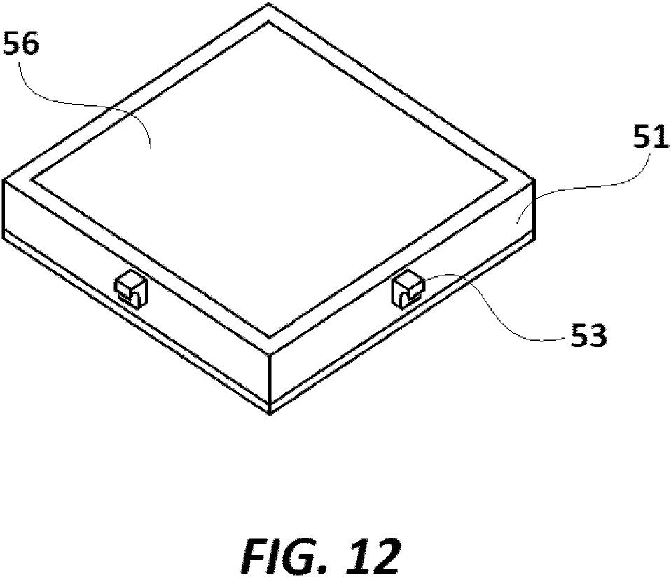

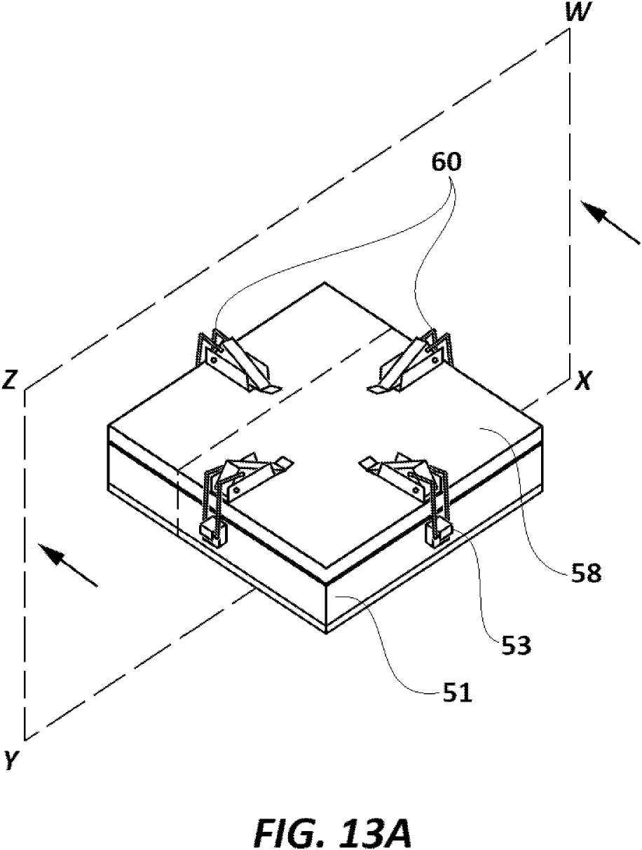

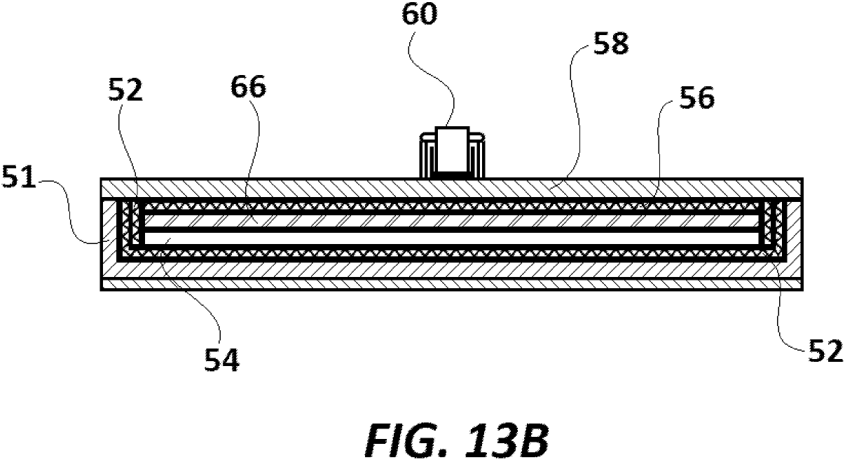

Referring to FIGS. 10A, 10B, a preferred lid mold 48 is constructed in a similar manner to container 44, with three layers: a bottom corrugated plastic layer formed by tray 52, a shrink-wrapped VIP panel 54 and an outer corrugated plastic cover 56. The construction of lid 48 can be carried out by using corrugated plastic tray 52 as the lower layer, placed into the mold base 51; placing a shrink-wrapped VIP panel 54 on top of tray 52; pouring in polyurethane (the structure at this stage of construction is shown in FIG. 11); placing a corrugated plastic pad 56 above shrink-wrapped VIP panel 54 polyurethane (the structure at this stage of construction is shown in FIG. 12); placing a mold cap 58 on top of plastic pad 56 and clamping it to mold base 51 using clamps 60 to hooks 53; while allowing foam setting to proceed. The mold cap 58 is released from tray 52 after foaming has completed and the polyurethane has hardened.

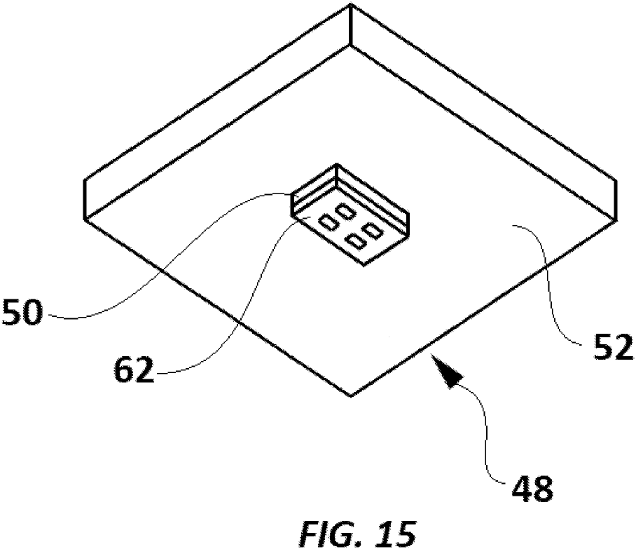

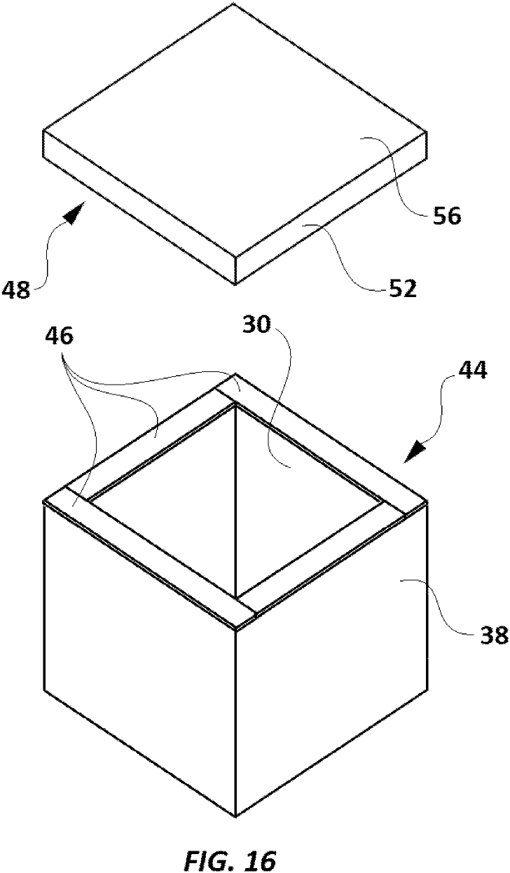

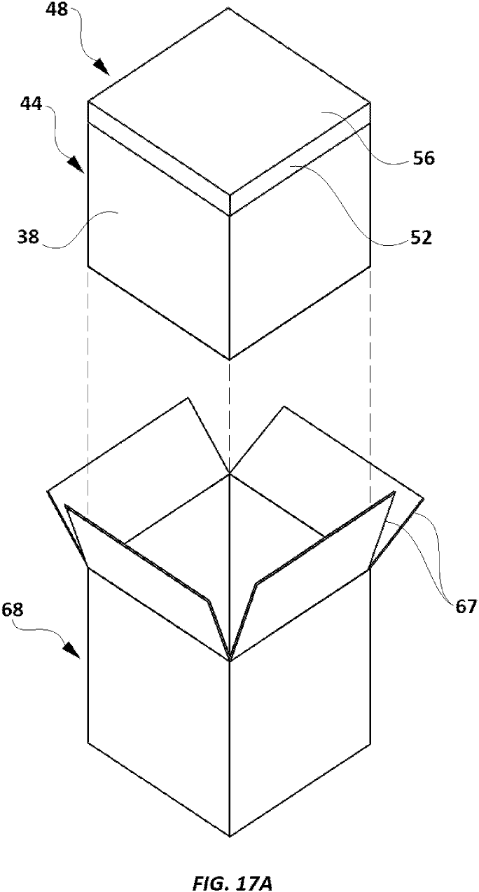

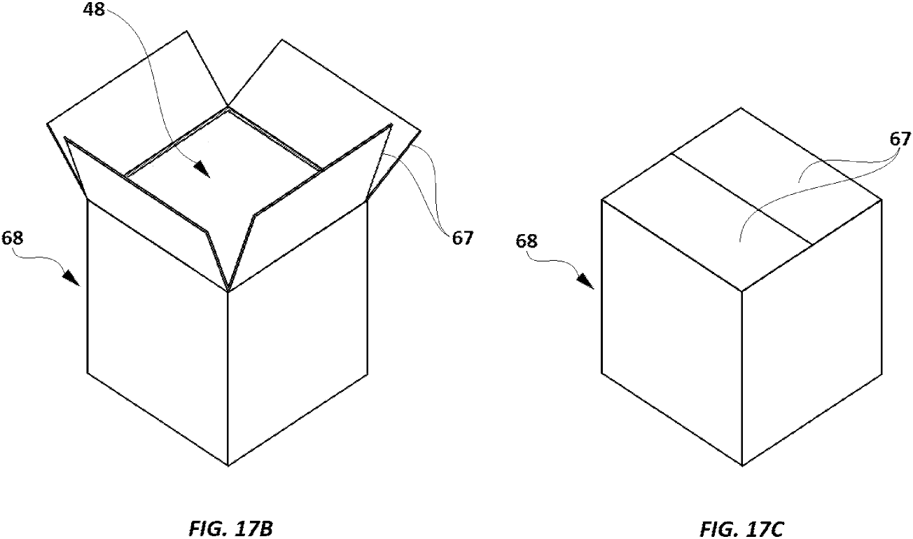

Optionally, a holder 50 for a temperature or humidity data logger 62 can be integrated into the inner side of lid 48 and/or into the inner sides of container 30 during or after construction, as shown in FIG. 15. Container 44 with lid 48 in place is finally placed inside an outermost corrugated box 68 with flaps 67, as shown in FIGS. 17A-17C. Box 68 protects the container 44 during shipment and can conveniently carry labels. One could add an internal payload box (not shown) to help further protect cargo during shipment. The temperature or humidity data logger 62 can either log data for later retrieval or transmit logged data wirelessly in real time.

Where the shipping container 44 is likely to be subject to high impacts or rough handling (i.e., during normal transport) adding a wireless data logger 62 which transmits the internal temperature of the container intermittently or in real time can be used to monitor the integrity of container 44, as well as the condition of the cargo. Suitable wireless data logger systems include the xTag Display™ used as part of the Mirador Express™, both available from Cryopak Digital (Roanoke, VA). They can be mounted in the holder 50, as shown in FIG. 15, or in a similarly situated holder placed anywhere on or inside shipping container 44, including on the outer side of outermost corrugated box 64.

The shipping container of the invention has the following advantages:

Excellent insulating properties to withstand transit harsh environments, with excellent vibration and impact resistance and absorption to help protect the VIP panels from structural damage;

The plastic corrugated outer layer covers all exposed VIP panel surfaces and makes the container easy to clean and sterilize;

The thermal performance of the VIP panels, which normally provide excellent insulation, is further improved by filling the gaps between VIP panel edges and between the VIP panels and adjacent container walls with polyurethane foam, to substantially reduce the otherwise present thermal bridge effect of such gaps;

Weather strips between container and lid improve the seal and the thermal performance, while allowing carbon dioxide release in dry ice applications. In one test using dry ice, the container of the invention maintained cargo temperature under -60° C. for more than 200 hours;

VIP panels coated in polyurethane foam also help isolate the VIP panel interiors from the environment, to slow the VIP panels losing vacuum pressure and extend the service life of VIP panels and the container; and

the shipping container of the invention is suitable for multiple uses and applications, and is relatively low cost.

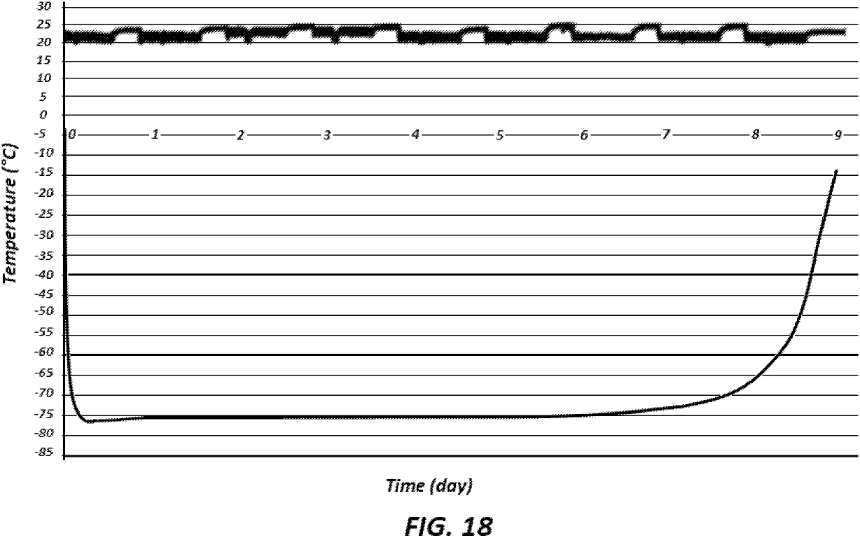

Referring to FIG. 18, it shows test results where a container of the invention contained dry ice as the coolant. The internal temperature stayed below 60° C. for over eight days.

### Example I

For determining if the integrity of the container has been negatively affected, one first establishes test temperature tracings with several of the containers of the invention, with the containers housing several different coolants; including dry ice, ice, and cold packs with phase change materials. The characteristic temperature increase within the containers for each coolant are plotted as standards, under a variety of ambient temperature conditions. Another set of test temperature tracings with several of the containers of the invention, each housing one of several different coolants, are determined for containers with breached VIP panels. A machine learning program can use the test sets to determine the rate or acceleration of temperature variation under particular ambient conditions which indicates a breached VIP panel.

With the test sets and standards generated, one can use them to compare to real-time temperature logging of containers used in shipment. Where the real-time logging shows a rate or acceleration in temperature variation in a container under the ambient temperature conditions, a breach of the integrity of the VIP panels can be indicated as the likely cause; an alert to a monitoring station can be issued, and the container can be flagged for inspection. If upon inspection an individual container is determined to be breached, the cargo can be moved to another container and shipping can proceed. Or the individual container and cargo can be placed into an appropriately temperature-controlled environment (e.g., refrigeration or a freezer) temporarily, and then the cargo can be shipped later.

The machine learning program can obtain the information from each breached individual container, and each container where the temperature variation indicated breach but where there was in fact no breach, to further refine the determination of what and how much temperature variation under particular ambient conditions is associated with a VIP panel breach. The monitoring cycles are repeated on each container.

The method for containers with the construction of the invention can be used for any shipping container to determine significant damage to it which affects its insulating characteristics.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, any of the terms “comprising”, “including”, containing”, etc. are to be read expansively and without limitation. The methods and processes illustratively described herein suitably may be practiced in differing orders of steps, and that they are not necessarily restricted to the orders of steps indicated herein or in the claims. It is also noted that as used herein and in the appended claims, the singular forms “a,” “an,” and “the” include plural reference, and the plural include singular forms, unless the context clearly dictates otherwise. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The invention has been described broadly and generically herein. Each of the narrower species and subgeneric groupings falling within the generic disclosure also form part of the invention. The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A process of making a thermal insulating shipping container, comprising:
forming a five-sided box wherein a bottom and four sides all have an inner layer of corrugated polymer, a middle layer of shrink-wrapped panels with each shrink-wrapped panel containing a vacuum, and an outer layer of corrugated polymer;
inserting polyurethane liquid into the gaps and spaces between the shrink-wrapped panels and the inner and outer layers;
foaming the polyurethane liquid and allowing the polyurethane to harden; and adhering weather stripping to the edges of the container which are opposite to the bottom of the container.

2. The method of claim 1 further comprising forming a lid for the container by providing lower and upper plastic corrugated layers and placing a shrink-wrapped vacuum insulated panel between the lower and upper lid layers, inserting polyurethane liquid into the gaps and spaces between the shrink-wrapped panels and the lower and upper lid layers, then foaming the polyurethane and allowing it to harden.

3. The method of claim 1 wherein the foaming is performed using a blowing agent.

4. The method of claim 1 wherein the blowing agent is hydrofluoroolefin HFO and water r.

5. A container formed by the process of claim 1.

6. A method of detecting damage to a first container having a particular construction, wherein the method comprises:
a. establishing test temperature tracings under multiple ambient temperatures with a first set of containers each having the particular construction and each housing a specified quantity of a coolant selected from the group consisting of dry ice, ice, and phase change material;
b. preparing a first series of standard curves for a characteristic temperature variation associated with each ambient temperature and each container in the first set and the coolant and quantity it houses;
c. preparing a second series of standard curves for a characteristic temperature variation associated with each container having the particular construction in a second set under multiple ambient temperatures, where each container in the second set houses a specified quantity of a coolant selected from the group consisting of dry ice, ice, and phase change material, but wherein each container in the second set has damage to one if its insulating components; and
d. (i) monitoring temperature variations in said first container which houses a specified quantity of one of the coolants and monitoring the ambient temperature, and correlating the temperature variations in said first container with said first and second series of standard curves at the same ambient temperature, and, if a correlation with said second series of standard curves is established, (ii) inspecting said first container to determine if one or more of its components is damaged; and e. repeating steps d(i) and d(ii) with another container having the particular construction which houses a specified quantity of one of the coolants.

7. The method of claim 6 wherein the correlation is determined using a machine learning program which is further provided information from said first container and each of said another container on whether said correlation with the second series is associated with one or more of their respective components being damaged.

8. The method of claim 6 wherein where step d(i) reveals one or more components being damaged, further including, moving any cargo in said damaged container to another container or moving said damaged container to a temperature-controlled environment.

9. The method of claim 8 wherein the temperature-controlled environment is a refrigerator or a freezer.

10. The method of claim 6 wherein the monitoring of temperature variations is performed with a wireless data logger.

11. A method of detecting a breach of vacuum panels in containers having:
a bottom, a lid and four sides each having an inner layer of corrugated polymer, a middle layer with a shrink-wrapped panel with each shrink-wrapped panel containing a vacuum, and an outer layer of corrugated polymer, wherein hardened polyurethane foam has been inserted into the gaps and spaces between the shrink-wrapped panels and the inner and outer layers;
wherein the method comprises:
a. establishing test temperature tracings with a first set of said containers each housing a specified quantity of a coolant selected from the group consisting of dry ice, ice, and phase change material;
b. preparing a first series of standard curves for a characteristic temperature variation associated with each container in the first set and the coolant and quantity it houses;
c. preparing a second series of standard curves for a characteristic temperature variation associated with each of said containers in a second set, where each container in the second set houses a specified quantity of a coolant selected from the group consisting of dry ice, ice, and phase change material, but wherein each container in the second set has at least one breached vacuum panel; and
d. (i) monitoring temperature variations in one of the containers which houses a specified quantity of one of the coolants and correlating the temperature variations in said one of the containers with said first and second series of standard curves, and, if a correlation with said second series of standard curves is established, (ii) inspecting said one of the containers to determine if it has one or more breached vacuum panels; and
e. repeating steps d(i) and d(ii) with another one of the containers which houses a specified quantity of one of the coolants.

12. The method of claim 11 wherein the correlation is determined using a machine learning program which is further provided information from each of said one of the containers on whether said correlation with the second series is associated with one or more breached vacuum panels in each of said one of the containers.

13. The method of claim 11 wherein where step d(i) reveals one or more breached vacuum panels, further including, moving any cargo in said breached container to another container or moving said breached container to a temperature-controlled environment.

14. The method of claim 13 wherein the temperature-controlled environment is a refrigerator or a freezer.

15. The method of claim 11 further including adding weather stripping between the edges of the container and the lid.

16. The method of claim 11 wherein the monitoring of temperature variations is performed with a wireless data logger.
